(19) United States
(12) Patent Application Publication
(10) Pub. No.: US 2016/0101373 A1
(43) Pub. Date: Apr. 14, 2016

(54) SYSTEMS AND METHODS FOR CONTROLLING NON-CONDENSABLE GASES

(71) Applicants: Hao WANG, Beijing (CN); EMPIRE TECHNOLOGY DEVELOPMENT LLC, Wilmington, DE (US)

(72) Inventor: Hao WANG, Beijing (CN)

(21) Appl. No.: 14/894,587

(22) PCT Filed: May 28, 2013
(86) PCT No.: PCT/CN2013/076307

§ 371 Date: Nov. 30, 2015

(51) Int. Cl. B01D 5/00

(52) U.S. Cl. CPC B01D 5/0051; B01D 5/0078

(57) ABSTRACT

Methods and systems for diffusing non-condensable gas are described. In an embodiment, a gas diffusion apparatus may be used to reduce non-condensable gas located adjacent to a condensation surface of a heat transfer system. The non-condensable gas may impede condensation at the condensation surface. The gas diffusion apparatus may include a plurality of blades arranged around a hub that is perpendicular to the condensation surface. The plurality of blades may rotate in a plane that is parallel or substantially parallel to the condensation surface. As the blades rotate, they generate gas flow that moves the non-condensable gas away from the condensation surface and imparts momentum on the vapor molecules heading toward the condensation surface. The blades may also contact the non-condensable gas layer and push them away from the condensation surface.

### BACKGROUND

Heat transfer systems operate through the evaporation and condensation of a liquid to manage the movement of heat between two surfaces. In general, a heat transfer system includes a heated evaporation surface that evaporates a liquid into a vapor. The vapor travels toward a condensation surface having a temperature that is cool enough to condense the vapor into a liquid. This evaporation-condensation cycle is used by processes such as water desalination, oil refining and industrial cooling for various purposes, such as reducing unwanted heat or removing certain particles from a liquid.

The efficiency of heat transfer is often influenced by non-condensable gases present at the condensation surface of the heat transfer system. The non-condensable gases, mostly air in a vapor, do not condense; rather, they accumulate on the condensation surface and form a gas layer which impedes condensation of the vapor. Heat transfer is diminished because the condensing vapor must diffuse through the non-condensable gas layer to reach the condensation surface. The non-condensable gases also lower the local vapor fraction at the condensation surface, which results in a lower local saturation temperature to condense the vapor into a liquid. Even trace amounts of non-condensable gases may introduce severe inefficiencies into a heat transfer system. For example, a mass fraction of non-condensable gases in vapor of 1% may lower heat transfer efficiency by about 60%. Conventional heat transfer systems are prone to inefficient operation because they do not adequately handle non-condensable gases.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a vapor condensation system may comprise a condensation surface configured to facilitate condensation of vapor thereon and a gas diffusion apparatus. The gas diffusion apparatus may comprise a plurality of blades configured to rotate in a plane perpendicular to a hub. The gas diffusion apparatus may be arranged such that the hub is perpendicular to the condensation surface. Rotation of the plurality of blades may be configured to promote condensation of vapor on the condensation surface by reducing an amount of non-condensable gas located adjacent to the condensation surface that impedes condensation of the vapor.

In an embodiment, a method for manufacturing a vapor condensation system may comprise providing a condensation surface configured to facilitate condensation of vapor thereon and arranging a gas diffusion apparatus comprising a plurality of blades configured to rotate in a plane perpendicular to a hub. The gas diffusion apparatus may be arranged such that the hub is perpendicular to the condensation surface. The rotation of the plurality of blades may be configured to promote condensation of vapor on the condensation surface by reducing an amount of non-condensable gas located adjacent to the condensation surface that impedes condensation of the vapor.

In an embodiment, a method for promoting condensation of vapor may comprise providing a condensation surface configured to facilitate condensation of vapor thereon, arranging a gas diffusion apparatus comprising a plurality of blades configured to rotate in a plane perpendicular to a hub, and providing a source of vapor. The gas diffusion apparatus may be arranged such that the hub is perpendicular to the condensation surface. The plurality of blades may be rotated to promote condensation of the vapor on the condensation surface by reducing an amount of non-condensable gas located adjacent to the condensation surface that impedes condensation of vapor.

In an embodiment, a heat transfer apparatus may comprise an evaporation surface configured to evaporate liquid in contact therewith to vapor, and a condensation surface configured to facilitate condensation of the vapor that contacts the condensation surface. The condensation surface may be arranged on the side of the heat transfer apparatus opposite the evaporation surface. The heat transfer apparatus may also comprise a gas diffusion apparatus comprising a plurality of blades configured to rotate in a plane perpendicular to a hub. The gas diffusion apparatus may be arranged such that the hub is perpendicular to the condensation surface. Rotation of the plurality of blades maybe configured to promote condensation of vapor on the condensation surface by reducing an amount of non-condensable gas located adjacent to the condensation surface that impedes condensation of the vapor.

In an embodiment, a gas diffusion apparatus may comprise a plurality of blades configured to rotate in a plane perpendicular to a hub. The gas diffusion apparatus may be arranged such that the hub is perpendicular to a condensation surface configured to facilitate condensation of vapor thereon. Rotation of the plurality of blades may be configured to promote condensation of vapor on the condensation surface by reducing an amount of non-condensable gas located adjacent to the condensation surface that impedes condensation of the vapor.

### BRIEF DESCRIPTION OF THE FIGURES

FIGS. 1A-1D depict illustrative heat transfer systems according to some embodiments.

FIGS. 2A and 2B depict operation of an illustrative condensation system according to some embodiments.

FIG. 3 depicts an illustrative flow field generated by an illustrative condensation system according to some embodiments.

FIG. 4 depicts an illustrative water treatment system according to some embodiments.

FIG. 5 depicts an illustrative desalination chamber according to some embodiments.

FIG. 6 depicts a flow diagram for an illustrative method of promoting condensation of vapor in a condensation system according to some embodiments.

### DETAILED DESCRIPTION

The following terms shall have, for the purposes of this application, the respective meanings set forth below.

A “heat transfer system” refers to a system configured to manage heat transfer between two surfaces. Heat transfer systems may be configured in various formations, including condensers, heat pipes, and vapor chambers. In general, a heat transfer system includes an evaporation interface that transfers heat to liquid in contact therewith. The liquid absorbs the heat provided by the evaporation interface and is evaporated into a vapor. The vapor travels toward a condensing interface that cools the vapor, which condenses as a liquid on the condensing interface, releasing latent heat in the process. The condensed liquid may return to the evaporation interface as part of an evaporation-condensation cycle and/or it may be captured as a product of the heat transfer system.

An “evaporation surface” refers to a surface where evaporation occurs, for example, in a heat transfer system. The evaporation surface may be heated by a heater that raises the temperature of the surface sufficient to evaporate a liquid of interest into a vapor.

A “condensation surface” refers to a surface where condensation occurs, for example, in a heat transfer system. In general, the condensation surface is configured to provide a cooling interface to condense vapor in contact therewith. Illustrative materials for condensation surfaces include metals such as aluminum and steel.

A “vapor condensation system” refers to a system configured to condense vapor, for example, within a heat transfer system. The vapor condensation system may include a condensation surface and other elements for supporting condensation, such as cooling devices to cool the condensation surface, elements to receive condensed liquid, and elements to move the condensed liquid away from the condensation surface, such as a drainage or wicking system.

“Non-condensable gas” refers to gas within a heat transfer system that will not condense on the condensation surface under normal operating temperatures and pressures. The non-condensable gas may accumulate around the condensation surface and impede condensation, for example, by blocking the vapor from contacting the condensation surface. Liquids used within a heat transfer system may contain small amounts of non-condensable gases. Evaporation of the liquids at the evaporation system may operate to release the non-condensable gases into the heat transfer system. Illustrative types of non-condensable gas include, without limitation, air, N₂, H₂, O₂, CO₂, and He.

A “gas diffusion apparatus” refers to an apparatus configured to disperse or otherwise reduce gases within a certain area. For instance, a gas diffusion apparatus may be used within a heat transfer system to diffuse gases, such as non-condensable gases. The gas diffusion apparatus may be located, for example, adjacent to a condensation surface to promote condensation. A gas diffusion apparatus may be configured in various formations, such as a fan-like apparatus having a plurality of blades that rotate around a central hub.

The present disclosure generally relates to promoting condensation at a condensation surface, for instance, within a heat transfer system. In an embodiment, efficient condensation at a condensation surface is promoted by reducing non-condensable gases at the condensation surface. In another embodiment, efficient condensation is promoted by increasing the flow of vapor to the condensation surface. Illustrative and non-restrictive examples of vapor include water, methanol, ethanol, petroleum distillates, benzene, and toluene. Embodiments provide for a gas diffusion apparatus configured to affect gas movement within a heat transfer system. The gas movement may operate to move non-condensable gas away from the condensation surface and/or to increase the flow of vapor to the condensation surface. The poor performance and failure of heat transfer systems leads to increased maintenance costs and energy consumption. However, pure vapor systems configured to eliminate non-condensable gases are extremely high-cost due to requirements for high vacuum, sealing, working fluid purification, and overall system complexity. As such, embodiments provide methods and systems for reducing and even eliminating the effects of non-condensable gas during the heat transfer process without the need for degassing or otherwise using a pure vapor system.

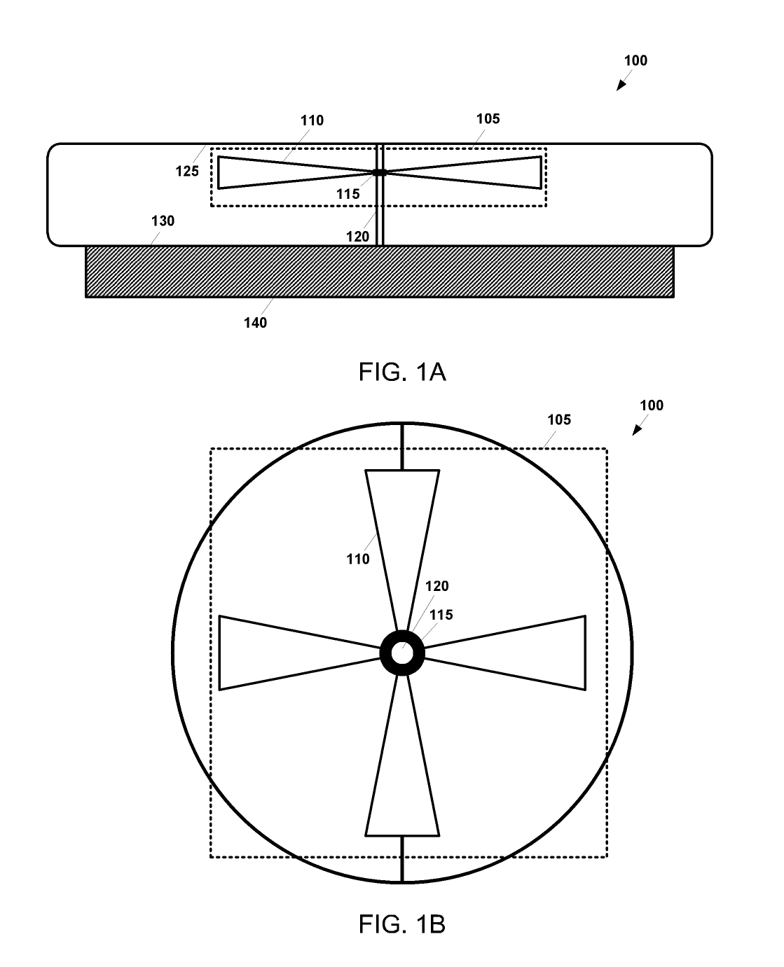

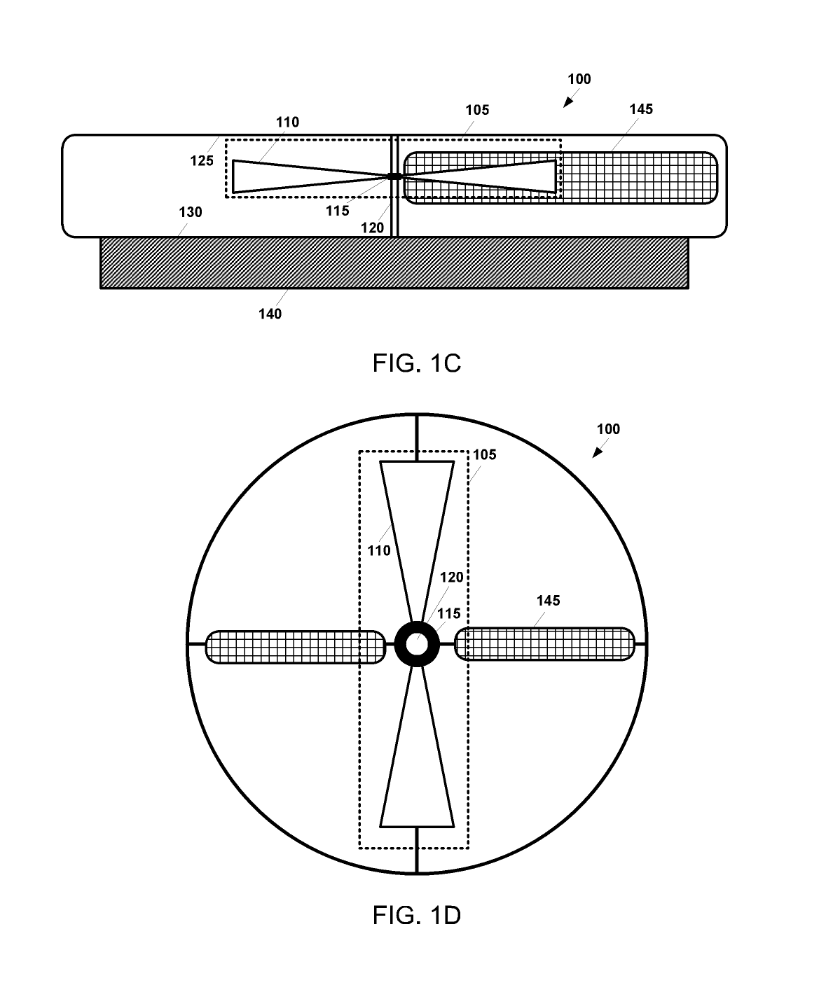

FIG. 1A depicts an illustrative heat transfer system according to some embodiments. As shown in FIG. 1A, a heat transfer system 100 may include a condensation surface 125 and an evaporation surface 130 heated by a heater 140. According to some embodiments, the heat transfer system 100 may be configured as part of a heat pipe, a condenser, a vapor chamber, a desalination system, a capillary-pumped loop, a distillation system, and/or a chemical separation system. A gas diffusion apparatus 105 (encompassed by the dotted lines) may be arranged within the heat transfer system 100. The gas diffusion apparatus 105 may comprise an axis 120, a hub 115, and a plurality of blades 110. In an embodiment, the gas diffusion apparatus 105 may be configured such that the plurality of blades 110 rotate in a plane perpendicular to the hub 115. The gas diffusion apparatus 105 maybe arranged such that the hub 115 is perpendicular or substantially perpendicular to the condensation surface 125. In this manner, the plurality of blades rotate in a plane that is parallel or substantially parallel to the condensation surface 125. Rotation of the plurality of blades 110 about the axis 120 may generate a gas flow within the heat transfer system 100. In an embodiment, the plurality of blades 110 may be configured to generate the gas flow at least partially directed toward the condensation surface 125.

FIG. 1B depicts a top-down view of the heat transfer system illustrated in FIG. 1A. As shown in FIG. 1B, the gas diffusion apparatus 105 may be arranged within the heat transfer system 100. The plurality of blades 110 are connected to a hub 115 configured to rotate around an axis 120. Although the plurality of blades 110 depicted in FIG. 1B are comprised of four blades, embodiments are not so limited, as any number of blades capable of operating according to embodiments are contemplated herein. For instance, the plurality of blades 110 may include 2, 3, 4, 5, or 6 blades.

FIGS. 1C and 1D depict a side view and a top-down view, respectively, of an illustrative heat transfer system including a liquid bridge according to some embodiments. As shown in FIGS. 1C and 1D, the heat transfer system 100 may further include a porous brush 145 (or liquid bridge). The first side of the porous brush 145 may be configured to slightly touch the condensation surface to collect the condensed liquid. A second side of the porous brush 145 may touch the evaporation surface to wet it. The porous brush 145, for example, may comprise a conduit configured to route condensed liquid within the heat transfer system 100, for example, to promote condensation. In one embodiment, the liquid bridge 145 may route the liquid away from sensitive elements being cooled through the heat transfer system, such as electronic components or components that may corrode due to extended contact with the liquid.

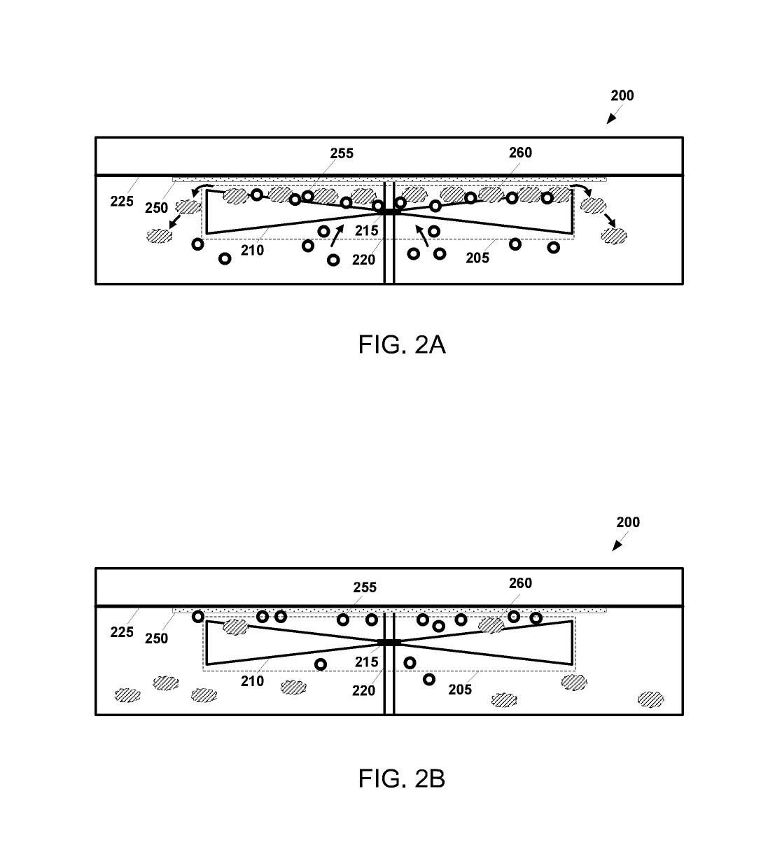

FIG. 2A depicts an illustrative condensation system according to some embodiments. As shown in FIG. 2A, a condensation system 200 may include a gas diffusion apparatus 205. According to embodiments, the condensation system 200 may be arranged within a heat transfer system, such as the heat transfer system 100 depicted in FIGS. 1A-1D. The gas diffusion apparatus may comprise a plurality of blades 210 configured to rotate about a hub 215 perpendicular or substantially perpendicular to the plurality of blades. The hub 215 may be configured to rotate about an axis 220 and may be arranged perpendicular or substantially perpendicular to a condensation surface 225 of the condensation system 200.

A condensate layer 250 may be formed on the condensation surface 225 as vapor 255 condenses on the condensation surface. Non-condensable gases 260 may collect adjacent to the condensation surface 225. The non-condensable gases 260 may reduce the ability of the vapor to condense at the condensation surface 225. For example, the non-condensable gas 260 may form a barrier that impedes the vapor from reaching the condensation surface 225. In another example, the non-condensable gases 260 may lower the local vapor fraction at the condensation surface, resulting in a lower local saturation temperature to condense the vapor into a liquid. Illustrative non-condensable gases include, without limitation, air, N₂, H₂, O₂, CO₂, and He.

As depicted in FIG. 2A, operation of the gas diffusion apparatus 205 may operate to generate a gas flow that moves non-condensable gases 260 away from the condensation surface 225 and/or moves vapor 255 toward the condensation surface. Such movement of the vapor 255 toward the condensation surface 225 gives the vapor molecules more momentum to the condensation surface, promoting condensation by allowing more vapor molecules to reach the condensation surface. In an embodiment, the gas flow may be about 0.5 meters/second (m/s), about 1 m/s, about 2 m/s, about 5 m/s, about 10 m/s, or in a range between any of these values (including endpoints). The plurality of blades 210 may be rotated at various speeds to generate gas flow. The velocity of the gas flow may be measured at the condensation surface using one or more flow velocity meters or detection devices. In an embodiment, the plurality of blades 210 may rotate at about 100 revolutions per minute (rpm), about 200 rpm, about 300 rpm, about 500 rpm, about 1000 rpm, about 1500 rpm, about 3000 rpm, or a range between any two of these values (including endpoints).

According to some embodiments, the plurality of blades 210 may be arranged close enough to the condensation surface 225 that they physically contact the non-condensable gases 260 during operation of the gas diffusion device 205. As such, the plurality of blades 210 may thin out and/or destroy the layer of non-condensable gases 260 and push it away from the condensation surface 225.

Embodiments provide that the plurality of blades 210 may be located as close as possible to the condensation surface 225 without interfering with condensation or gas flow while moving non-condensable gas 260 away from the condensation surface and/or moving vapor 255 toward the condensation surface. In an embodiment, the plurality of blades 210 may be positioned at a particular distance from the condensation surface 225. According to some embodiments, the particular distance may be about 0.01 millimeters (mm), about 0.05 mm, about 0.1 mm, about 0.25 mm, about 0.5 mm, about 1 mm, about 5 mm, about 10 mm, about 25 mm, about 50 mm, about 100 mm, about 500 mm, about 1000 mm, or ranges between any two of these values (including endpoints).

FIG. 2B depicts an illustrative condensation system according to some embodiments. More specifically, FIG. 2B depicts the condensation system 200 of FIG. 2A wherein operation of the gas diffusion apparatus 205 has diffused a portion of the non-condensable gas 260 from the condensation surface 225 and facilitated the movement of the vapor 255 toward the condensation surface. In an embodiment, the non-condensable gas 260 may be moved away from the condensation surface 225 and toward an evaporation surface, such as the evaporation surface 130 of the heat transfer system 100 of FIG. 1A. In this manner, evaporation heat transfer may be enhanced at the evaporation surface (e.g., evaporation surface 130) due to a lower local vapor pressure at the evaporation surface caused by the presence of the non-condensable gases 260. As such, the gas diffusion apparatus 205 may operate to enhance both the condensation and the evaporation of a system, such as the heat transfer system 100 depicted in FIGS. 1A-1D. Accordingly, rotation of the plurality of blades 210 may increases an efficiency of heat transfer above the efficiency of heat transfer of the heat transfer apparatus without rotation of the plurality of blades. For example, the efficiency of heat transfer may increase by about 10%, about 25%, about 33%, about 50%, about 70%, about 100%, about 200%, about 300%, about 400%, about 500%, about 750%, and a range between any two of these numbers (including endpoints).

Only the vapor 255 molecules that reach the condensation surface 225 have a chance to condense. The amount of these vapor molecules 255 may be defined as follows:

$$j = Γ ( a ) \sqrt{\frac{\overline{M}}{2 π \overline{R}}} \frac{P}{{mT}^{1 / 2}} .$$

Where Γ(a) is a factor representing the influence of vapor bulk flow, Γ(a)≈1+aπ^{1/2}, wherein a is proportional to the bulk flow velocity towards the condensation surface 225, wherein M̅ is the molecular weight, R̅ is the universal gas constant, P is the pressure, T is the temperature, and m is the molecular mass. When the vapor bulk is moving towards the condensation surface 225, Γ(a) is larger and, thus, more vapor 255 molecules can reach the condensation surface and condense. The impinging flow induced by the plurality of blades 210 gives the vapor 255 molecules more momentum directed toward the condensation surface 225. Accordingly, more vapor molecules can reach the condensation surface 225 and condense.

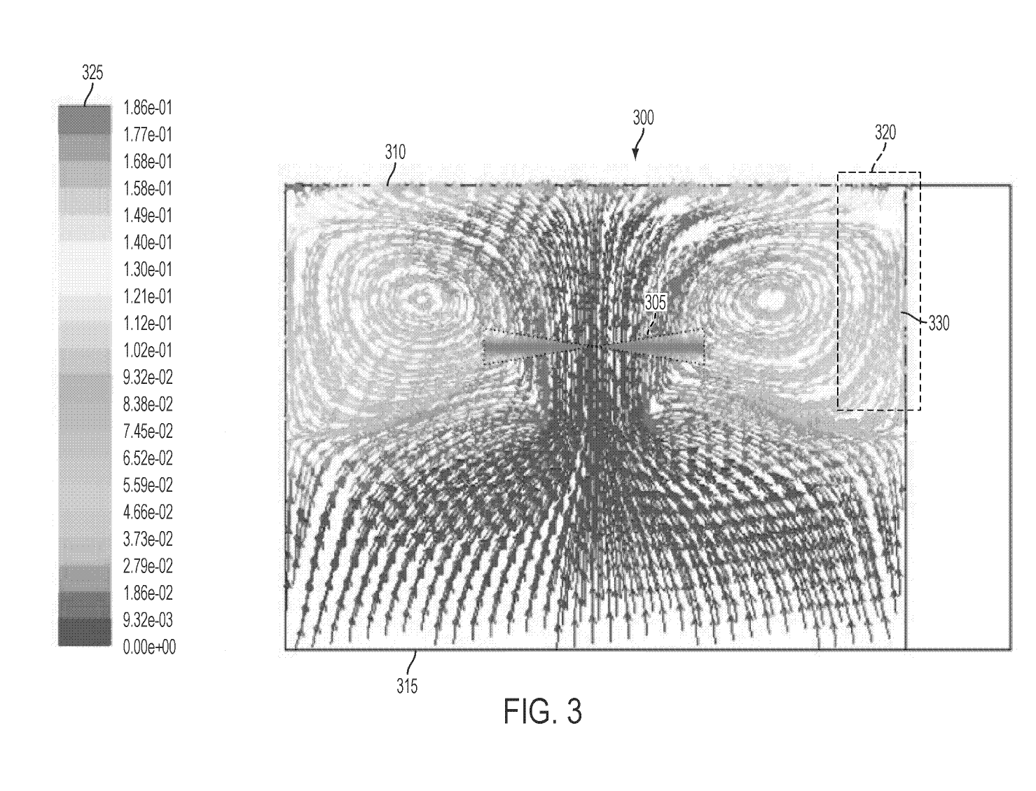

FIG. 3 depicts an illustrative flow field generated by an illustrative condensation system according to some embodiments. As shown in FIG. 3, a gas diffusion apparatus 305 may be arranged within a condensation system 315. Operation of the gas diffusion apparatus 305 may generate a flow field 300 that moves non-condensable gas within the condensation system 315. A legend 325 provides the concentration of non-condensable gases shown in FIG. 3. As the gas diffusion apparatus 305 operates, the non-condensable gas may be pushed to a side wall 330 of the condensation system 315, as highlighted in the dashed area 320. As depicted in FIG. 3, the concentration of non-condensable gas may be diminished at the condensation surface 310 through operation of the gas diffusion apparatus 305.

Embodiments provide that a gas diffusion apparatus as described herein may be used in various systems. Illustrative and non-restrictive examples of systems that may use a gas diffusion apparatus include heat pipes, condensers, vapor chambers, desalination systems (e.g., seawater desalination systems), capillary-pumped loops, distillation systems, and chemical separation systems.

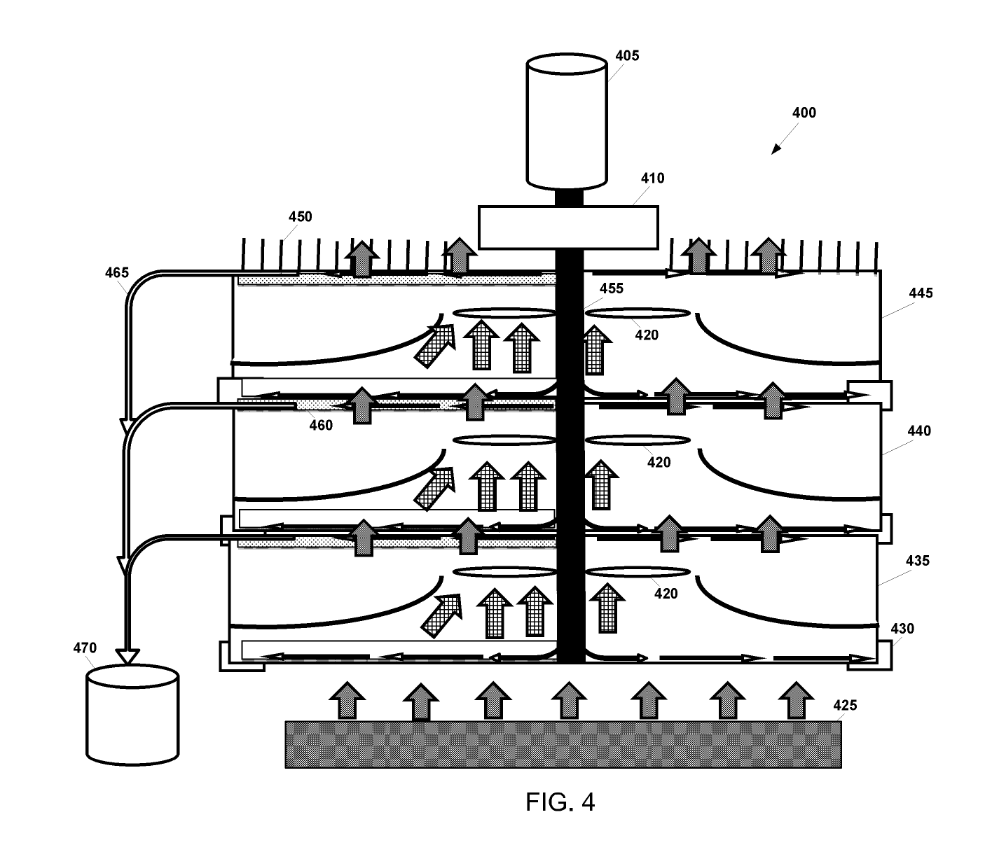

FIG. 4 depicts an illustrative water treatment system utilizing gas diffusion devices according to some embodiments. As shown in FIG. 4, a water treatment system 400 may comprise a supply of untreated water 405 that will be treated by the water treatment system. The water treatment system 400 may comprise multiple tiers 435, 440, 445 having a generally similar configuration. A pipe system 455 may be configured to receive the untreated water 405, for example, pumped using a driving motor 410. The condensation-evaporation system 400 may further include a preheating apparatus 450. The untreated water 405 may be heated by a heater 425 and evaporate. The evaporated untreated water 405 may move through the water treatment system 400 condensing on a condensation surface 460 on one of the tiers 435, 440, 445, depending on where it travels through the system. Each condensation surface 460 may be associated with a gas diffusion apparatus 420 configured to promote condensation on each respective condensation surface 460 according to embodiments described herein. In various embodiments, the topmost condensation surface 460 may be thermally connected to the preheating apparatus 450 and may be configured to provide heat from the condensation of vapor to the preheating apparatus 450. In some embodiments, the preheating apparatus 450 may be configured to receive fluid, such as fluid from areas surrounding the evaporation-condensation system 400. In some embodiments, the preheating apparatus 450 may be configured to heat the fluid with the heat obtained from the topmost condensation surface 460. Unwanted material (e.g., brine, dirt) may be collected at one or more collectors 430 for removal from the water treatment system 400. The condensed liquid may be collected and travel through one or more treated water pathways 465 for collection in a treated water container 470.

In an embodiment, the pressures in all the tiers may be near atmospheric pressure. If degassing and pressure control are conducted, the evaporation-condensation process may be enhanced, allowing for more tiers. Various water treatment systems may operate according to the water treatment system 400 depicted in FIG. 4, such as a water distillation or desalination system.

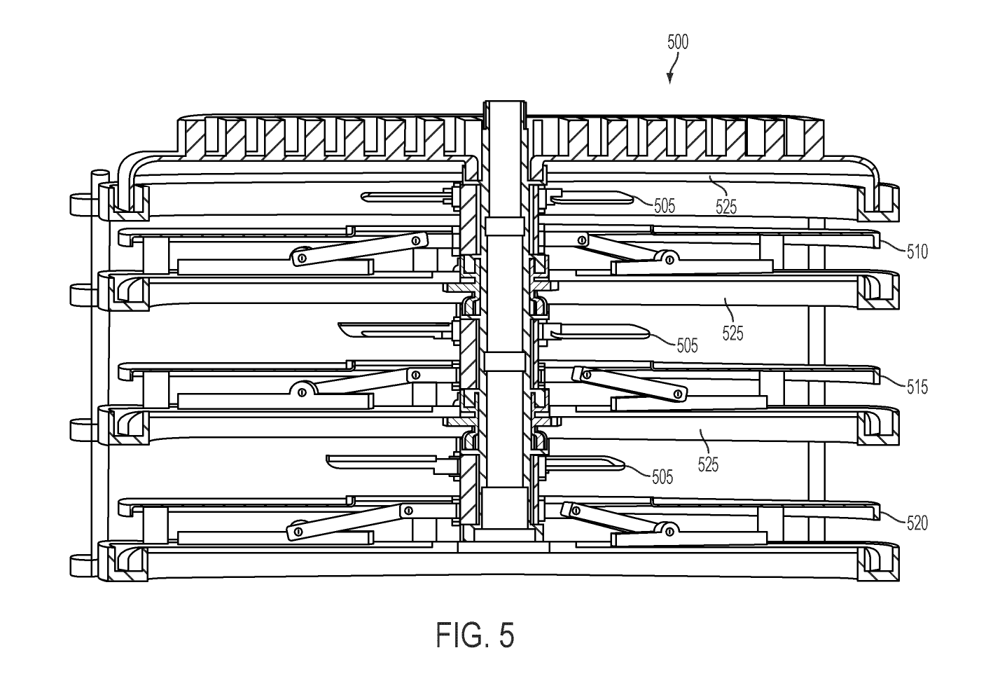

FIG. 5 depicts a longitudinal side-view of an illustrative desalination chamber according to some embodiments. As shown in FIG. 5, a desalination chamber 500 may comprise multiple tiers 510, 515, 520, similar to the system depicted in FIG. 4. The desalination chamber system 500 may be enclosed within a casing (not shown). Each tier 510, 515, 520 may include a condensation surface 525 associated with a gas diffusion apparatus 505 configured to promote condensation on each respective condensation surface according to embodiments described herein. In an embodiment, each tier 510, 515, 520 may be configured as a “pan,” wherein the lower surface of one pan serves as the condensation surface of the pan located below. For example, the lower surface of tier 510 may serve as the condensation surface 525 of tier 515, and so on. In an embodiment, each upper tier, or stage, has a larger area than its respective lower tier such that the lower “pans” can be stored in the upper bigger pans. Each tier 510, 515, 520 may be configured as a module, such that tiers may be added or removed from the desalination chamber 500 to customize the system. The desalination chamber 500 may be configured as a portable desalination chamber, facilitated by the modularity of its components. In an embodiment, the gas diffusion apparatus may be manually operated or powered by a small electric motor as appropriate for a portable device.

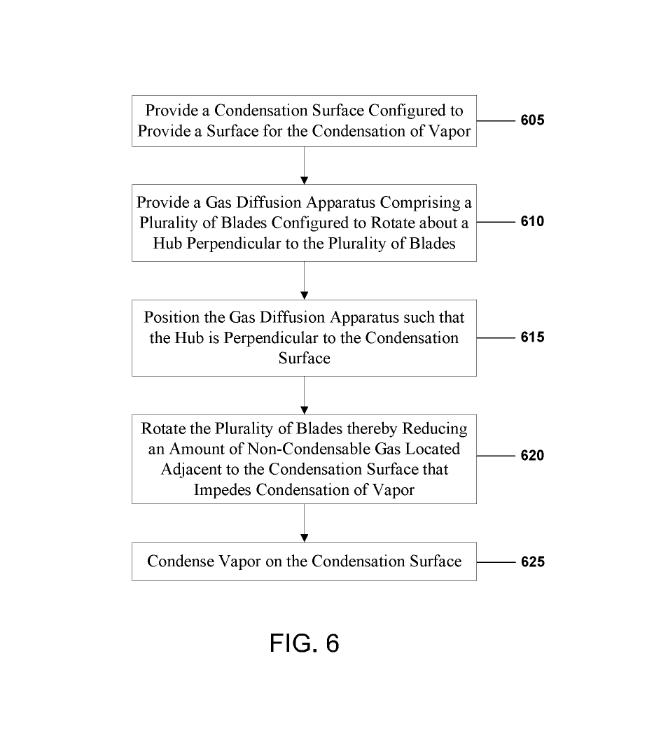

FIG. 6 depicts a flow diagram for an illustrative method of promoting condensation of vapor in a condensation system according to some embodiments. A condensation surface may be provided 605 as a surface for the condensation of vapor. For example, the condensation surface may be a surface within a heat transfer system having a temperature that will cause a vapor of interest to condense responsive to contact therewith. A non-limiting example provides that the temperature of the condensation surface may be about at a temperature below the boiling point of the liquid being used in the heat transfer system.

A gas diffusion apparatus may be provided 610 that comprises a plurality of blades configured to rotate about a hub perpendicular to the plurality of blades. Embodiments provide that the plurality of blades may have any configuration and may be arranged in any manner capable of operating according to embodiments described herein. For example, each of the plurality of blades may be pitched at an angle of about 15° along a longitudinal axis of each of the plurality of blades with respect to a plane perpendicular to the hub. In another example, the gas diffusion apparatus may comprise 2 blades. Further examples provide that the gas diffusion apparatus may comprise 3, 4, 5, or 6 blades.

The gas diffusion apparatus may be positioned 615 such that the hub is perpendicular to the condensation surface. In this manner, the plurality of blades rotate in a plane parallel or substantially parallel to the condensation surface. The plurality of blades may be rotated 620, thereby reducing an amount of non-condensable gas located adjacent or substantially adjacent to the condensation surface that operates to impede condensation of vapor. Rotation of the plurality of blades generates gas flow toward the condensation surface that moves the non-condensable gas away from the condensation surface and toward, for example, the side walls and/or evaporation surface of a heat transfer system. Reducing the non-condensable gases at the condensation surface operates to promote condensation by removing a barrier for vapor reaching the condensation surface and by raising the condensation temperature at the condensation surface. Rotation of the plurality of blades may increase condensation efficiency within a system (e.g., vapor condensation system, heat transfer apparatus, etc.) as compared to the condensation efficiency of the system without rotation of the plurality of blades. For example, condensation efficiency may increase by about 10%, by about 25%, by about 33%, by about 50%, by about 75%, by about 100%, by about 200%, and ranges between any two of these (including endpoints) above condensation efficiency of a system without rotation of the plurality of blades.

Vapor may be condensed 625 on the condensation surface. For instance, a vapor may be provided (e.g., evaporated liquid from an evaporation surface) that condenses on contact with the condensation surface. The gas diffusion apparatus may operate to increase the amount of vapor contacting the condensation surface and to raise the condensation temperature at the condensation surface, thereby promoting condensation within a heat transfer system.

### EXAMPLES

### Example 1

### Heat Pipe

An oil refinery will be equipped with a heat pipe configured to manage the temperature of equipment during the refining process. The body of the heat pipe will be made out of titanium and will house an evaporation surface and a condensation surface. The evaporation surface will receive heat energy from the equipment, which will evaporate liquid water to generate water vapor. The temperature of the evaporation surface will be about 375 Kelvin (K). The water vapor will travel toward a condensation surface configured to condense water vapor that contacts its surface. The temperature at the condensation surface will be about 370 K.

When the mass fraction of non-condensable gases within the heat pipe is zero (that is, there is no non-condensable gas in the system), the condensation mass rate of the heat pipe is about 0.95 grams/second (g/s). A layer of non-condensable gas is located adjacent to the condensation surface having a gas mass fraction of about 1.1%. When the non-condensable gas mass fraction is about 1.1%, the condensation rate drops to about 0.44 g/s, a reduction of about 54%. When the non-condensable gas mass fraction is about 10%, the condensation rate is reduced to about 0.07 g/s, a reduction of about 93%.

The heat pipe includes a gas diffusion apparatus comprising four blades. The gas diffusion apparatus is located about 50 mm from the condensation surface and is positioned such that the blades rotate substantially parallel with respect to the condensation surface. The gas diffusion apparatus will be initiated to rotate the four blades during operation of the heat pipe. Rotation of the blades will generate gas flow of 2 m/s toward the condensation surface that moves the water vapor from the condensation surface and toward the evaporation surface. Rotation of the blades will additionally cause the blades to contact the layer of non-condensable gas, thinning the layer and pushing a portion of the non-condensable gas away from the condensation surface.

When the non-condensable gas mass fraction is about 1.1%, the condensation rate will be about 0.75 g/s with the use of the gas diffusion apparatus, about a 70% increase over a heat pipe without the gas diffusion apparatus. When the non-condensable gas mass fraction is about 10%, the condensation rate will be about 0.42 g/s with the use of the gas diffusion apparatus, about a 500% increase over the condensation rate achieved using a heat pipe without the gas diffusion apparatus.

### Example 2

### Central Processing Unit Heat Transfer System

A computing system will have a heat transfer system configured to cool a central processing unit (CPU). The heat transfer system will have a chamber made out of copper and will have a thickness of about 5 mm, a width of about 6 cm, and a length of about 3 cm. The chamber will include an evaporation surface located on the side of the chamber contacting the CPU and a condensation surface on the opposite side of the chamber. A gas diffusion apparatus including two blades will be positioned about 25 mm from the condensation surface and will be configured to rotate the blades in a plane substantially parallel to the condensation surface. The chamber will house an electric motor configured to rotate the blades.

The CPU will operate without cooling at a temperature of about 100° C., thereby heating the evaporation side to about 79° C. The temperature of the condensation surface will be configured to be about 77° C. during operation of the CPU. Non-condensable gases will collect near the condensation surface, impeding condensation of Ethanol.

The gas diffusion device will operate to generate a gas flow directed toward the condensation surface. The gas flow will push the non-condensable gas toward the side of the chamber and back toward the evaporation surface and will push the ethanol vapor toward the condensation surface. The reduction in the amount of non-condensable gas will allow more ethanol vapor to reach the condensation surface and will increase the local condensation temperature at the condensation surface. The ethanol will condense on the condenser, and the liquid ethanol will return toward the evaporation surface through a liquid bridge. The evaporation-condensation cycle generated through operation of the heat transfer system will reduce the temperature of the CPU to about 65° C.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A vapor condensation system comprising:
a condensation surface configured to facilitate condensation of vapor thereon; and
a gas diffusion apparatus comprising a plurality of blades configured to rotate in a plane that is perpendicular to a hub, the gas diffusion apparatus being arranged such that the hub is perpendicular to the condensation surface, wherein rotation of the plurality of blades is configured to promote condensation of vapor on the condensation surface by reducing an amount of non-condensable gas located adjacent to the condensation surface that impedes condensation of the vapor.

2. The vapor condensation system of claim 1, wherein the vapor comprises one or more of the following: water, methanol, ethanol, petroleum distillates, benzene, and toluene.

3. (canceled)

4. The vapor condensation system of claim 1, wherein the gas diffusion apparatus is positioned within a distance from the condensation surface such that the plurality of blades is in contact with at least a portion of the amount of non-condensable gas.

5. The vapor condensation system of claim 4, wherein rotation of the plurality of blades reduces the amount of non-condensable gas by pushing the non-condensable gas away from the condensation surface.

6. (canceled)

7. The vapor condensation system of claim 4, wherein the distance is about 0.1 mm to about 1,000 mm.

8.-10. (canceled)

11. The vapor condensation system of claim 1, wherein rotation of the plurality of blades is further configured to promote condensation by increasing a momentum of vapor movement toward the condensation surface.

12. The vapor condensation system of claim 1, wherein rotation of the plurality of blades is further configured to promote condensation by increasing an amount of vapor reaching the condensation surface.

13. The vapor condensation system of claim 1, wherein the plurality of blades is configured to rotate at about 100 revolutions per minute to about 3000 revolutions per minute.

14. The vapor condensation system of claim 1, wherein rotation of the plurality of blades generates a gas flow of about 0.1 m/s to about 10 m/s.

15.-16. (canceled)

17. The vapor condensation system of claim 1, wherein a horizontal plane of each of the plurality of blades comprises a substantially triangular shape.

18. The vapor condensation system of claim 1, wherein each of the plurality of blades is pitched at an angle of about 15° along a longitudinal axis of each of the plurality of blades with respect to a plane perpendicular to the hub.

19.-37. (canceled)

38. A method for promoting condensation of vapor, the method comprising:
providing a condensation surface configured to facilitate condensation of vapor thereon;
arranging a gas diffusion apparatus comprising a plurality of blades configured to rotate in a plane that is perpendicular to a hub, the gas diffusion apparatus being arranged such that the hub is perpendicular to the condensation surface;
providing a source of vapor; and
rotating the plurality of blades to promote condensation of the vapor on the condensation surface by reducing an amount of non-condensable gas located adjacent to the condensation surface that impedes condensation of the vapor.

39. (canceled)

40. The method of claim 38, further comprising collecting at least a portion of the vapor condensing on the condensation surface.

41. The method of claim 38, wherein reducing the amount of non-condensable gas comprises generating a gas flow that moves the non-condensable gas away from the condensation surface.

42. The method of claim 38, wherein arranging the gas diffusion apparatus comprises positioning the gas diffusion apparatus within a distance from the condensation surface such that the plurality of blades is in contact with at least a portion of the amount of non-condensable gas.

43. (canceled)

44. The method of claim 42, wherein positioning the gas diffusion apparatus comprises positioning within a distance of about 0.1 mm to about 1000 mm.

45.-47. (canceled)

48. The method of claim 38, wherein rotating the plurality of blades further promotes condensation by increasing a momentum of vapor movement toward the condensation surface.

49. The method of claim 38, wherein rotating the plurality of blades further promotes condensation by increasing an amount of vapor reaching the condensation surface.

50. The method of claim 38, wherein rotating the plurality of blades comprises rotating the plurality of blades at about 100 revolutions per minute to about 3000 revolutions per minute.

51. The method of claim 38, wherein rotating the plurality of blades comprises rotating the plurality of blades to generate a gas flow of about 0.1 m/s to about 10 m/s.

52. A heat transfer apparatus comprising:
an evaporation surface configured to evaporate liquid in contact therewith to vapor;
a condensation surface configured to facilitate condensation of the vapor thereon, the condensation surface being arranged opposite to the evaporation surface; and
a gas diffusion apparatus comprising a plurality of blades configured to rotate in a plane that is perpendicular to a hub, the gas diffusion apparatus being arranged such that the hub is perpendicular to the condensation surface, wherein rotation of the plurality of blades is configured to promote condensation of vapor on the condensation surface by reducing an amount of non-condensable gas located adjacent to the condensation surface that impedes condensation of the vapor.

53. (canceled)

54. The heat transfer apparatus of claim 52, wherein rotation of the plurality of blades moves the non-condensable gas away from the condensation surface and toward the evaporation surface.

55. The heat transfer apparatus of claim 54, wherein movement of the non-condensable gas toward the evaporation surface promotes evaporative heat transfer by lowering a local vapor pressure at the evaporation surface, thereby promoting evaporation of the liquid in contact with the evaporation surface.

56. The heat transfer apparatus of claim 52, wherein rotation of the plurality of blades increases an efficiency of heat transfer by about 70% to about 500% above the efficiency of heat transfer of the heat transfer apparatus without rotation of the plurality of blades.

57.-72. (canceled)
